(19) United States
(12) Patent Application Publication
(10) Pub. No.: US 2014/0332458 A1
(43) Pub. Date: Nov. 13, 2014

(54) REGENERATIVE FLUID FILTRATION MICRO-CELL

(71) Applicant: FiltraSonics LLC, Denver, CO (US)

(72) Inventors: Joseph D. Cohen, Denver, CO (US); Neel Duncan, Castle Rock, CO (US)

(73) Assignee: FiltraSonics LLC, Denver, CO (US)

(21) Appl. No.: 14/273,368

(22) Filed: May 8, 2014

Related U.S. Application Data
(60) Provisional application No. 61/821,024, filed on May 8, 2013.

(51) Int. Cl. B01D 24/46

(52) U.S. Cl. CPC B01D 24/4631
USPC 210/275

(57) ABSTRACT

Aspects of the present disclosure involve systems, methods, products, and the like, for a filtration system that incorporates a plurality of back-washable filter cells into a cell manifold for filtering contaminants from a fluid. Each of the filter cells of the filter system are a small fluid filtration unit that includes a contained granular filtration media that can independently perform regenerative filtration functions of filtration and backwash. In one particular embodiment, the cell manifold is a cylindrical-shaped manifold into which the plurality of filter cells are housed. During operation, the filter system passes fluid through one or more of the filter cells of the cell manifold during a filter cycle, and distributes fluid for backwashing the cells in a backwash cycle. The filter cells of the filtration system utilize a counter-point compaction of the granular media that radially displaces outwardly the granular media.

### RELATED APPLICATIONS

This application claims priority under 35 U.S.C. § 119 from U.S. provisional application No. 61/821,024 entitled “RADIAL FLOW FLUID FILTRATION CELL,” filed on May 8, 2013, the entire contents of which are fully incorporated by reference herein for all purposes.

### TECHNICAL FIELD

Aspects of the present disclosure generally relate to water filtration systems in which water or other fluids are filtered through a granular filtration media (GFM) to remove dissolved or suspended material from the fluid. In particular, the present disclosure relates to water filtration systems that utilize a plurality of filtration cells in a manifold, each filtration cell configured such that fluid passes through the GFM and material dissolved or suspended in the fluid is removed by and collects in the GFM, and the material so collected is subsequently removed from the GFM by backwashing or other media regeneration process in preparation for a next filtration cycle.

### BACKGROUND

Water or other type of fluid filters often use a regenerative fluid filtration process that utilizes GFM contained in a pressure vessel through which the unfiltered fluid is passed to be filtered or otherwise treated. One such filter, described as a Radial Flow Filtration (RFF), is described in U.S. Pat. No. 5,882,531 to Joseph D. Cohen and is incorporated by reference herein. Generally and as described in the Cohen reference, the filtration process of this type of filtration system utilizes a body of GFM, captivated between two screened media barriers which operate to mechanically compact the GFM into a tightly packed filtration bed for fluid filtration when the screened media barriers forcefully converge. The unfiltered fluid is then passed through the compacted GFM which acts to filter out the contaminants from the fluid.

Periodically, filters that utilize a granular media for filtering are cleaned to remove the contaminants trapped by the GFM. To clean an RFF-type filter when loaded with contaminant, the filter typically releases the compaction force on the GFM by diverging the two screened media barriers, which in turn increases the volume of the GFM. The GFM is then subjected to a high velocity backwash through one or more jets, flushing the contaminants into a waste discharge connection. After the GFM has been backwashed clean, the RFF filter then re-compacts the GFM by once again having the two screened media barriers forcefully converge on the GFM to begin the next filtration cycle. Other types of conventional filters that utilize granular media to filter the fluid rely on gravitational packing of the granular media or hydrodynamic packing of the granular media to compact the granular media in the filter.

While effective as a filter, there exist many challenges and difficulties in developing RFF GFM filters. For example, it is often difficult to reliably compact a large mass of GFM into an evenly distributed and evenly compacted filter bed. Disproportionate distribution of the GFM can cause filter malfunction by leaving some loose grains, or in some instances, even creating voids within the media bed which can allow fluid to pass through the filter without being filtered. Further, it may also be difficult to quickly and thoroughly fluidize the entire body of the GFM for a quick and efficient backwash cleaning. It is with these and other issues in mind that various aspects of the present disclosure were developed.

### SUMMARY

It is an object of the present disclosure to provide a filter device which evenly distributes and mechanically compacts a granular filtration media (GFM) for the filtration of fluids at the beginning of each filtration cycle.

It is further an object of the present disclosure to provide a filtration apparatus which can dependably compact GFM to narrow bed depths.

It is further an object of the present disclosure to provide a filter device which utilizes a plurality of small, easy-to-change, modular, back-washable, filtration cells with permanent GFM such that each cell is independently capable of regenerative fluid filtration.

It is an object of the present disclosure to provide a filter system which is more cost effective to operate than conventional filters.

One implementation of the present disclosure may take the form of a filter system. The filter system includes a housing comprising an influent pipe for input of a contaminated fluid into the housing and an effluent pipe for output of a filtered fluid from the housing, a cell manifold enclosed in the housing and a plurality of filter cells maintained on the cell manifold. Each of the plurality of filter cells comprises a granular filtration media (GFM) maintained within a media chamber, a compaction element to compact the GFM within the media chamber and a backwash jet to fluidize the GFM during a backwash cycle. Further, each of the plurality of filter cells is configured to filter contaminates out of the contaminated fluid by passing the contaminated fluid through the GFM.

Another implementation of the present disclosure may take the form of a filter device for filtering contaminates from a fluid. The device includes a cell manifold and a plurality of filter cells maintained on the cell manifold. Each filter cell of the plurality of filter cells include at least one fluid-tight seal located between the filter cell and the cell manifold, a granular filtration media (GFM) maintained within a media chamber, a compaction element configured to compact the GFM within the media chamber and a backwash jet to fluidize the GFM during a backwash cycle. Each of the plurality of filter cells is configured to filter contaminates out of a contaminated fluid by passing the contaminated fluid through the compacted GFM.

### BRIEF DESCRIPTION OF THE DRAWINGS

FIG. 1 is a cross section view of a first embodiment of a filter system including a plurality of filter cells maintained on a cell manifold.

FIG. 2 is an isometric view of a second embodiment of a filter system, utilizing a cuboid cell manifold and a plurality of filter cells.

FIG. 3 is a cross section view of a filter cell of a filter system.

FIG. 4 is a cross section view of the filter cell of a filter system of FIG. 4, including flow indicators illustrating the flow of fluid through the filter cell during a filtering cycle.

FIG. 5 is a cross section view of the filter cell of a filter system including flow indicators illustrating the flow of fluid through the filter cell during a backwash cycle.

FIG. 6 is a cross section view of one embodiment of a compaction element of a filter cell of a filter system that utilizes positive displacement compaction of the GFM.

FIG. 7 is a cross section view of one embodiment of a filter cell of a filter system that utilizes center point compaction of the GFM of the filter cell.

### DETAILED DESCRIPTION

Aspects of the present disclosure involve systems, methods, products, and the like, for a filtration system that incorporates a plurality of filter cells into a cell manifold or a pipe manifold for filtering contaminants from a fluid. Each of the filter cells of the filter system is typically a small fluid filtration unit that can independently perform regenerative filtration functions of filtration and backwash. In one particular embodiment, the cell manifold is a cylindrical-shaped manifold into which the plurality of filter cells are housed and sealed. During operation, the filter system passes fluid through one or more of the filter cells of the cell manifold during a filter cycle, and also provides filtered fluid for backwashing the cells in a backwash cycle. The filter cells are generally secured to the cell manifold with a retaining means (such as a fluid-tight seal), so as to not blow out of the cell manifold during the backwash cycle. Other embodiments of the cell manifold may take any type of shape and size, perhaps to be packaged into different types of filter tanks. Such shapes include, but are not limited to, a sphere, a geodesic sphere, a cylindroid, a disc, a cube, a cuboid, and a prism. In yet other embodiments, the filtration cell (or cell manifolds in some embodiments) is designed to fit into a pipe fitting socket, such a Polyvinyl Chloride (PVC) pipe, without the use of a cell manifold. Further, the pipe may be manifolded to accommodate a plurality of cells.

The one or more filter cells of the filtration system may include several features that aid in the filtration of a fluid through the filtration system. In particular, due to the small size of the filter cells relative to a larger filter cell in the system, a thin bed thickness of the GFM may be reliably utilized within each filter cell to filter the fluid. Such thin bed thickness is not typically available in larger filters to obtain the same filtering effect. Further, in some filter cell embodiments, the filter cells utilize a center-point compaction of the GFM that radially displaces outwardly the GFM, rather than merely compacting the media into a flat bed. This displacement of the GFM allows for a bed thickness of the GFM that increases along the radial length of the media chamber. In addition, by utilizing a cylindrical or conical shaped compactor, the filter cell may achieve an increased media interface size when compared with a flat compaction of the GFM. By increasing the area of the interface of the GFM (while maintaining a small size of the filter cell in general), a large flow of fluid through the filter is achieved at a relatively fast rate. These and other benefits obtained through the filter cells of the filtration system are discussed in greater detail below.

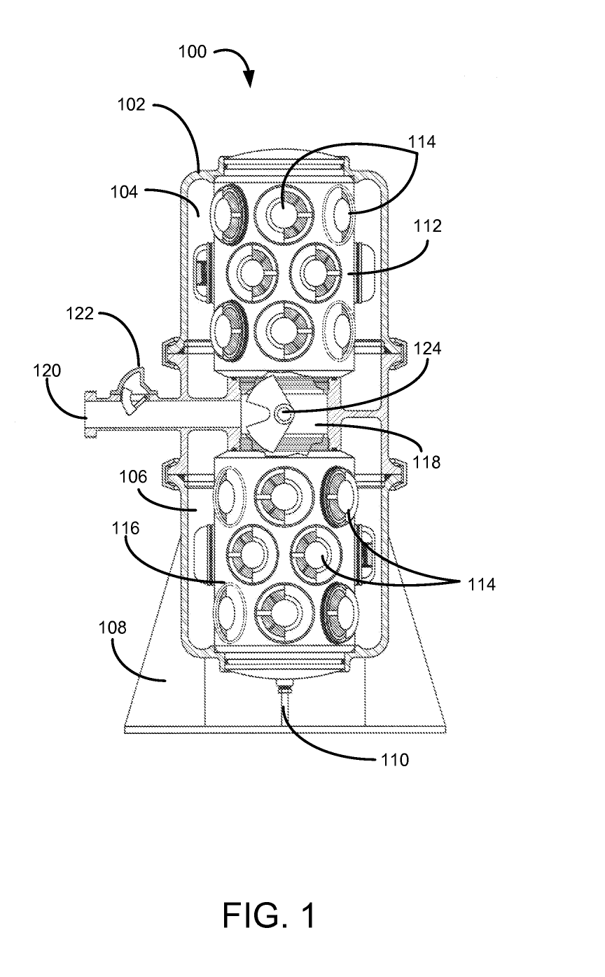

FIG. 1 is a cross section view of a first embodiment of a filter system including a plurality of filter cells maintained on a cell manifold. The embodiment illustrated in FIG. 1 is but one example of a filtering system that utilizes a plurality of filter cells mounted on a cell manifold. In general, the filter system that includes a plurality of filter cells may take any shape and size as needed for filtering fluids.

The filter system 100 of FIG. 1 includes an outer housing 102 comprising an upper jacket 104 and a lower jacket 106. In the embodiment illustrated in FIG. 1, the upper jacket 104 and the lower jacket 106 are cylindrical in shape, being closed on one end and open on the opposite end. The open end of the upper jacket 104 and the open end of the lower jacket 106 are constructed to meet and create a fluid-tight seal in which a cell manifold 103 and a plurality of filter cells 114 maintained on the cell manifold are housed. During a filtering phase of the filter system 100, unfiltered fluid is pumped into and contained within the housings 102, 106 to pass through the plurality of filter cells 114 of the cell manifold 103 for filtering of the fluid. The housing 102 also may include a pedestal base 108 such that the filter 100 may stand upright when placed on the base. A drain plug 110 may also be included at the bottom of the housing 102 for draining the fluid from the housing 102 for serving or winterizing the system 100 and other maintenance reasons.

Housed within the housing 102 is a cell manifold 103 with a plurality of filter cells 114 disposed thereon. In particular, the cell manifold 103 includes an upper cell manifold 112 and a first group of the plurality of filter cells 114. In the embodiment shown in FIG. 1, eighteen such filter cells 114 are disposed on the upper cell manifold 112. Similarly, the cell manifold 103 includes a lower cell manifold 116 and a second group of the plurality of filter cells 114. In the embodiment shown in FIG. 1, eighteen such filter cells 114 are disposed on the lower cell manifold 116. Although the filter system 100 illustrated in FIG. 1 includes 36 total filter cells 114 disposed on the cell manifold 103, it should be appreciated that any number of filter cells may be present. For example, the upper cell manifold 112 and the lower cell manifold 116 may each include a single filter cell 114. In addition, it is not required that the upper cell manifold 112 include the same number of filter cells 114 as the lower cell manifold 116. In general, the filter cells 114 are oriented in the cell manifold 103 such that fluid is filtered by passing from within the housing 102 but outside the cell manifold, through the filter cells, and into the interior of the cell manifold created by the upper cell manifold 112 and the lower cell manifold 116.

During filtration, unfiltered fluid enters the housing 102 through one or more influent pipes (not shown) connected or otherwise in fluid communication with the filtering system 100. In general, the housing 102 is constructed fluid-tight such that fluid may be maintained between the cell manifold and the interior walls of the housing. During a filtering cycle of the system 100, the fluid passes through the plurality of filter cells 114 maintained in the cell manifold 103 into the interior of the cell manifold such that contaminates in the fluid are filtered out by the filter cells. The filtered fluid is then maintained within the interior of the cell manifold 103 such that the filtered fluid is not mixed with the contaminated fluid maintained within the housing 102 but outside the cell manifold. After being filtered, the fluid may flow into the filtered fluid chamber 118 between the upper manifold 112 and the lower manifold 116 and out an effluent pipe 120 of the filter system 100. In one embodiment, a flow meter 122 may be incorporated into the effluent pipe 120 to measure the rate of flow through the effluent pipe during operation of the filtering system 100 to let the operator know how much the flow has been reduced by dirt, and when the filter is to be backwashed.

As mentioned above, the filter system 100 may also include a backwashing or cleaning cycle that cleans the GFM bed of one or more of the filter cells 114 of the system. While particular details of the backwashing cycle for the individual filter cells 114 are described in more detail below, the filter system 100 may include a control valve 124 that may aid in the backwashing cycle of the filter cells of the system. In general, the control valve 124 includes sealing valves to direct influent and effluent flow from the upper housing 104 and the lower housing 106, in addition to a restrictor valve that creates high pressure within the upper cell manifold 112 or lower cell manifold 116 to aid in the backwash cycle for each. The control valve 124 thus has three positions corresponding to three phases of the filter system 100. A first position of the control valve 124 corresponds to a filtering phase of the filter system 100. In this position, the influent fluid is diverted by the control valve 124 to both the upper housing 104 and the lower housing 106 for filtering of the fluid.

A second position of the control valve 124 corresponds to a backwashing phase of the upper manifold 112. In this position, influent fluid is diverted to the lower manifold 104 where filtering of the fluid continues. Also, the control valve 124 diverts filtered fluid from the lower manifold 116 to the upper manifold 112 that may be used by the upper manifold 112 to perform reverse flow backwashing on the filter cells of the upper manifold. Further, a restrictor valve may also be incorporated into the control valve 124 that creates high pressure within the upper manifold 112 to aid in the backwashing of the filter cells 114 of the upper manifold, as explained in more detail below. Finally, the control valve 124 also includes a sealing valve that diverts fluid from the upper housing 104 to an effluent waste connection for discharge of wash water to sewer or other appropriate locations. In this manner, activation of the control valve 124 causes filtered fluid from the lower manifold 116 to the upper manifold 112 under high pressure, causing reverse flow backwashing of the filter cells 114. The backwashed fluid then flows into the upper housing 104 and out the waste connection.

Similarly, a third position of the control valve 124 corresponds to a backwashing phase of the lower manifold 116. In this position, filtered fluid from the upper manifold 112 flows into the lower manifold 116 under high pressure. The filtered fluid from the upper manifold 112 may be used by the lower manifold 116 to perform reverse flow backwashing of the filter cells 114 of the lower manifold. The control valve 124 also includes the sealing valve that diverts backwashed fluid (wash water) into the waste connection. In this manner, activation of the control valve 124 causes filtered fluid from the upper manifold 112 to the lower manifold 116 under high pressure, causing reverse flow backwashing of the filter cells 114 of the lower manifold. One embodiment of the control valve and its operation is described in U.S. patent application Ser. No. 13/773,848 to Cohen et al., the entirety of which is incorporated by reference herein.

The use of a plurality of filter cells 114 in a filter system provides several advantages over previous filter designs. For example, the cell approach to fluid filtration allows for using different types of GFM filters in the same filter system during the filtration process. The use of different GFMs within the filter system can be accomplished in at least two ways. First, a blend of multiple GFMs can be put into one or more of the filter cells 114. The use of multiple GFMs allows for the filter cell 114 to filter different types of contaminants or perform different types of filtering of the fluid passing through the GFMs. Further, the quick and turbulent backwash cycle prevents these different media from stratifying according to their density, and this blend of multiple GFM will desirably remain homogenized so that all the fluid being filtered will come in contact with all the different GFM during each filtration pass.

A second way to introduce multiple GFMs into the filter system 100 includes plug cells with different GFMs into the cell manifold 102. In this embodiment, one or more filter cells 114 of the system 100 may include a first type of GFM for filtering, while one or more other filter cells of the system may include a second type of GFM for filtering. With this embodiment, only a portion of the fluid flow will go to each different GFM. In some filtration applications, this is desirable. The use of various GFMs within the filter system 100 provides flexibility to the type of filtering performed by the system and the type of contaminants filtered by the system, such as dissolved or suspended contaminants.

Another advantage provided through the filter system 100 described herein is the ability to quickly install new filter cells 114 into the cell manifold. In particular, because the GFM of the filter cells 114 are typically sealed within the cell, replacement of filter cells can be simply accomplished by removing the filter cell and replacing it with a new filter cell. Thus, there is no need to add or deal with the GFM to install the filter cell or during a backwash procedure of the filter cell.

Yet another advantage of the filter system 100 that utilizes filter cells 114 is the versatility of filter system design. For example, the filter cells 114 can be can be installed in a manifold and completely submerged inside a filter tank or housing, or they can be installed semi-submerged onto the wall of the filter tank or housing and interconnected externally with tubing or pipe. Yet a third installation may locate the filter cells without the use of a filter tank into manifolds of tubing or pipe. Because conventional backwash-capable filters requires a filter tank, the filter system 100 of FIG. 1 provides for much less dirty wash water to displace with clean water within the tubing or pipe than there would be inside a relatively large filter tank.

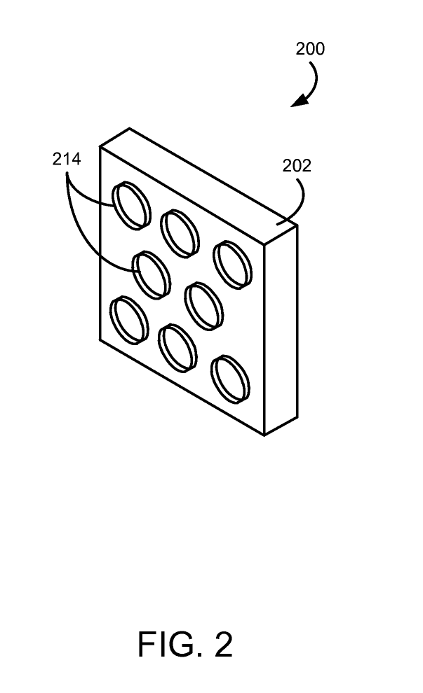

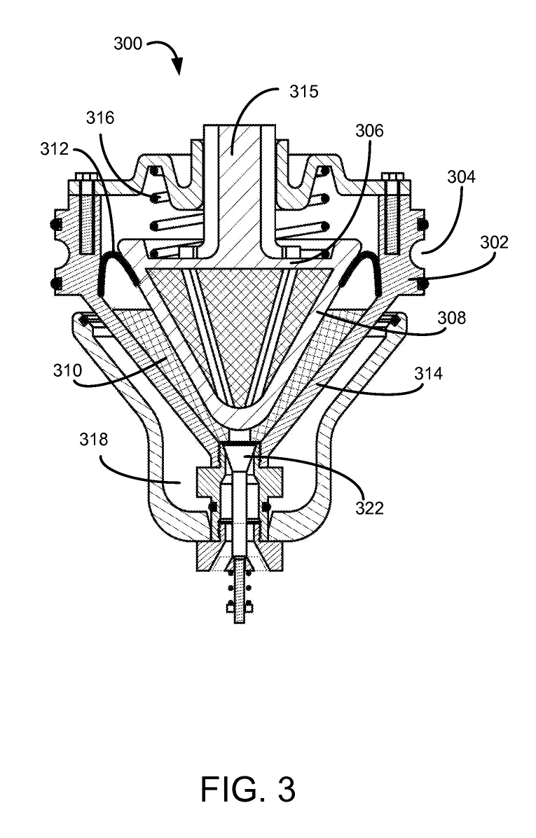

FIG. 3 is an isometric view of another embodiment of the filter system, utilizing a cuboid cell manifold and a plurality of filter cells. In general, the operation of the filter system 200 of FIG. 2 is similar to the filter system 100 of FIG. 1. Namely, a plurality of filter cells 214 are maintained in a cell manifold 202 through which a fluid is passed to filter contaminants from the fluid. In contrast to the system of FIG. 1, the filter system 200 of FIG. 2 utilizes a cuboid cell manifold 202 instead of a cylindrical manifold. Use of the cuboid shape of the cell manifold 202 may be in response to a housing of the filter system in which the manifold is placed. In general, the cell manifold may take any shape, such as a geodesic sphere, a cylindroid, a disc, a cube, a cuboid, and a prism to adjust to the environment in which the filter system is installed or placed. The systems of FIG. 1 and FIG. 2 are merely two examples of such filter system shapes and embodiments.

An example embodiment filter cell of the plurality of filter cells 114 of the filter system 100 is illustrated in FIG. 3. In particular, FIG. 3 is a cross section view of a filter cell 300 of a filter system, such as the filter system 100 of FIG. 1. In general, each of the filter cells 114 of the filter systems described above may take the form of the filter cell 300 embodiment of FIG. 3. However, it should be appreciated that the filter cells 114 of the filter systems described above may take the form of any filter that utilizes mechanically-compacted GFM to perform fluid filteration and with regenerative backwash functionality configured to discharge contaminants filtered from a fluid. The filter cell 300 of FIG. 3 is but one example of such a filter cell.

Filter cell 300 is generally conical in shape and includes various permeable surfaces situated such that contaminated fluid may enter the filter cell at or near the top of the cell, pass through the permeable surfaces and the compacted GFM to filter out the contaminants, and exit the cell at or near the bottom of the cell. In one particular embodiment, the outer shell 302 of the filter cell 300 includes a mounting indention 304 that may house a seal (such as an o-ring type seal). As mentioned above, one or more of such filter cells 300 may be maintained on a cell manifold as part of a filter system. The seal housed in the mounting indention 304 of the filter cell 300 creates a fluid-tight seal between the filter cell and the cell manifold to prevent fluid from passing into the interior of the cell manifold without first being filtered through the filter cell.

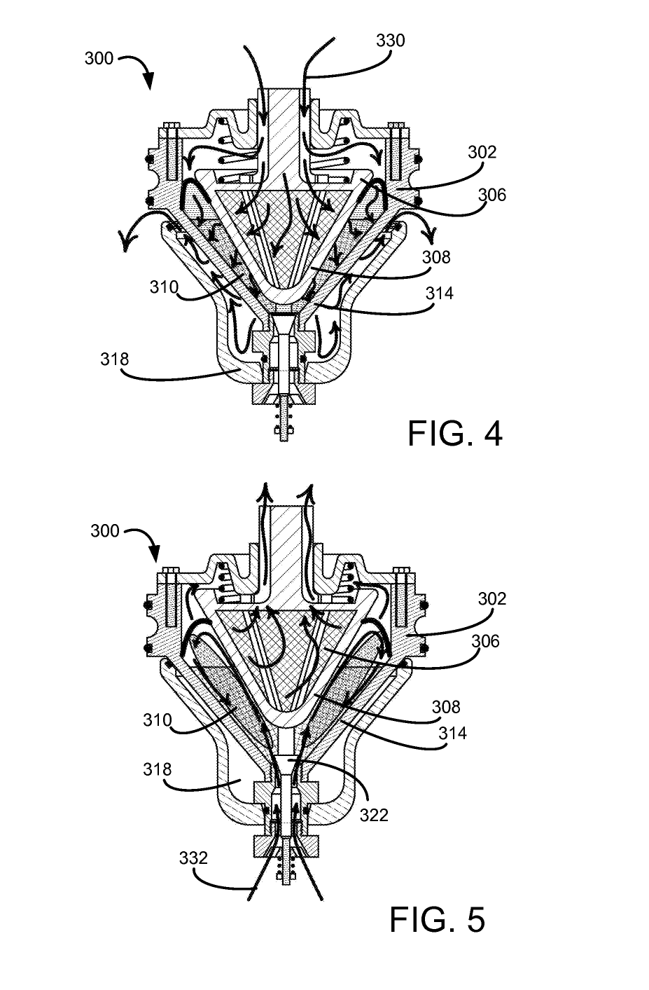

Internally, the filter cell 300 includes a compaction piston 306 generally configured to compact GFM 311 within the filter cell to create a permeable substance to filter fluid flowing through the filter cell. The compaction piston 306 is generally conical in shape and includes a first permeable surface, media barrier screen, or dirty screen 308 that comprises the bottom portion of the compaction piston. The compaction piston 306 is oriented within the filter cell 300 such that the point of the conical shape of the piston is pointed toward the bottom of the cell. In one embodiment, the compaction piston 306 includes a series of support ribs which support the dirty screen 308 of the compaction piston to maintain the conical shape of the piston. The dirty screen 308 of the compaction piston 306 has both the functions of retaining the GFM 311 within a media chamber 310 (discussed in more detail below) and screening out coarse debris present in the influent fluid. For example, the filtering action of the filter cell is best seen in FIG. 4. As shown in FIG. 4, fluid 330 enters the filter cell 300 at the top of the cell and flows into the interior of the compaction piston 306. Because the dirty screen 308 of the compaction piston 306 is permeable, the fluid is allowed to pass through the screen into the bottom portion of the filter cell 300. The dirty screen 308 of the compaction piston 306 operates to filter out large particles in the fluid as it passes through the dirty screen of the piston.

In general, the dirty screen 308 may be produced from woven material or perforated material. Perforated material is produced with round holes and is less apt to trap debris and media. Woven material has square or rectangular holes that tend to trap debris and media. This happens when the solid gets into the rectangular hole on the long diagonal and then twists and jams on the shorter parallel in the fluid flow. In another embodiment, the compaction piston may include a dirty screen comprising a plurality of narrow slots, thereby eliminating the woven material or perforated material screen of the dirty screen.

Beneath the compaction piston 306 in the filter cell 300 is a media chamber 310. The media chamber 310 contains the GFM of the filter cell 300. A rolling seal 312 is maintained between the top of the compaction piston 306 and the internal wall 302 of the filter cell to ensure that the GFM of the filter cell remains captivated within the media chamber 310 throughout the filter and backwash cycles. In one embodiment, the rolling seal 312 is constructed from the same or a similar material as the dirty screen 308 so as to provide an additional screen surface through which the fluid may pass from the upper portion of the seal into the media chamber 310. Although a rolling seal 312 is illustrated in the embodiment of FIG. 3, it should be appreciated that any type of flexible seal may be utilized in the filter cell 300 to captivate the GFM in the media chamber 310 while also providing a range of movement to the compaction piston 306, including having the rolling seal be made of a woven material similar to the dirty screen 308 of the compaction piston.

As discussed above, the filter system may utilize a body of GFM 311 captivated between two screened media barriers of which one or both operate to mechanically compact the granular media into a tightly packed filtration bed for fluid filtration when the screened media barriers are forcefully converged. One type of granular media 311 for such a filter may be a non-sintered, buoyant filter media such as an ultra-high molecular weight polyethylene (UHMW) type material. One type of such UHMW is described in U.S. patent application Ser. No. 13/653,637 to McGrady et al., the entirety of which is incorporated by reference herein. However, it is contemplated that any type of GFM may be utilized with the filter embodiments described herein. In the filter cell 300 embodiment of FIG. 3, the compaction piston 306 exerts a compaction force onto the GFM 311 contained in the media chamber 310 to create a GFM filtration bed packed to minimum void. A second screen media barrier 314 is located on the underside of the granular bed that defines the bottom surface of the media chamber 310. The compacted GFM bed 311 operates to filter contaminates from the fluid passing through the filter cell. In particular and referring again to FIG. 4, the fluid is illustrated as passing through the compacted GFM contained within the media chamber 310 and filtered by the GFM. Further, the fluid then flows through the permeable second screen media barrier 314 that defines the bottom of the media chamber 310. This second screen 314 functions to captivate the GFM 311 in the media chamber 310. The second screen 314 may be comprised from screen, perforated or a slotted material. Thus, in one embodiment, rather than the second screen media barrier 314 being of a woven material, in one embodiment the bottom of the media chamber 310 includes a series of thin slits in an otherwise solid base that allows fluid to pass through the slits while maintaining the GFM 311 within the media chamber. It is through the action of passing the fluid through media barrier screen 308 in the compaction piston 306 and the compacted GFM 311 of the media chamber 310 that filters the contaminates from the fluid to provide a clean fluid at the bottom of the filter cell 300.

To compact the GFM 311 in the media chamber 310, a biasing component is connected to or otherwise associated with the compaction piston 306 and configured to force the compaction piston into the GFM in the media chamber 310. In the embodiment shown in FIG. 3, a biasing spring 316 is located between the top of the filter cell and the compaction piston 306 that biases the piston toward the bottom of the filter cell. An additional hydraulic downward force is also present on the compaction piston 306 as fluid passes into the cell 300 and through the dirty barrier 308 of the compaction piston. In other words, the force of the flow of fluid through the dirty barrier 308 of the compaction piston 306 also acts to bias the compaction piston into the GFM of the media chamber 310. Although shown as a biasing spring 316 in FIG. 3, other embodiments of the filter cell 300 may include other types of biasing mechanisms. For example, biasing mechanism 316 may include any type of mechanical, motorized, electrical solenoid, pneumatic, hydraulic, and hydrodynamic resistance, or any combination of these that operate to bias the compaction piston and apply a force into the GFM 311. Further operation and benefits of the compaction of the GFM 311 by the compaction piston 306 are discussed below.

In one embodiment, an orienting shaft 315 is located within the biasing spring 316. The orienting shaft 315 operates to center the compaction piston 306 into the center or near the center of the media chamber 310. The orienting shaft 315 aids the compaction piston 316 in centering on the GFM 311 and uniformly compacting the GFM in the media chamber 430 such that voids in the compacted GFM are not present.

Returning to FIG. 4, the operation of the bell check 318 of the filter cell 300 is described. In particular, filtered fluid 330 passes out of the second media screen barrier 314 of the media chamber 310 and into a bell check 318 located on the bottom portion of the filter cell 300. The bell check 318 allows for the filtered fluid to then flow out and over the rim of the bell check and into a cell manifold or filtered fluid container for use by the fluid system.

Often, conventional filter systems that utilize a GFM for filtering periodically clean the GFM to remove the contaminants trapped by the GFM during the filtration phase. To provide the backwash cleaning feature, the filter cell 300 of FIG. 3 includes a backwash jet 320 preferably located at the bottom center of the cell. The backwash jet 320 is oriented in the filter cell 300 to provide a high velocity jet of fluid directly into the GFM 311 contained within the media chamber 310 to agitate and otherwise wash the media. Because the GFM 311 is contained within the screened walls of the cell, a high velocity backwash of the GFM may occur without a loss of GFM from the cell 300. Further, because the cell does not rely on gravity to settle or otherwise compact the GFM 311, the cell 300 may be used in any orientation. In particular, the highly turbulent fluidization of the GFM by the backwash jets during the backwash cycle, followed by the quick forceful re-compaction of the GFM by the compaction piston 306 to begin the next filtration cycle prevents gravity from distributing or stratifying the GFM. Basically, the cell 300 and neutralizes and overcomes any effect gravity has on the GFM and the filtration process, and therefore could operate in a weightless environment, such as a space station.

In general, the backwash jet or jets 322 are located directly within the body of the GFM 311 within the cell 300. The GFM 311, being confined within the media chamber 310 inside the cell 300, is thus kept in close proximity to the backwash jets 322. The cell 300 is designed to provide unobstructed water jet power through the backwash jets 322 to quickly and forcefully fluidize the GFM 311 during the backwash cycle and power wash it clean.

Conventional permanent media backwash filters expand their filter beds of GFM upwards with reverse water flow during the backwash cycle. This conventional method limits backwash velocity to a maximum velocity, because a higher backwash velocity will carry their GFM right out of the filter tank and the filter will fail to work in the next filtration cycle. In contrast, the filter cell 300 of FIG. 3 includes GFM 311 that is confined within the small space of the media chamber 310, and thus always kept in close proximity to the powerful, high velocity backwash jets 322. Because of the contained GFM 311, a quick, water stingy, powerful and thorough backwash cleaning of the GFM can take place. The backwash jet 322 of the filter cell 300 thus provides a powerful, high pressure, cleaning wash cycle that both works fast and also conserves fluid, such as water in most applications.

In one embodiment of the cell 300, the backwash jet 322 may be a direct injection valve that incorporates a one-way check valve in its flow path, similar to an intake valve on an internal combustion engine. In general, the backwash jet 322 is spring-loaded to be biased closed during filtering operation of the filter cell 300 to captivate the GFM inside the cell during filtration. However, when the backwash jet 322 is subjected to a high pressure reverse flow during a backwash cycle (activated through the use of the control valve 124 discussed above with reference to FIG. 1), the backwash jet 322 opens and fluid is allowed to flow into the cell at high velocity through the backwash jet. In other words, the control valve 124 operation creates a high pressure within the cell manifold 112. The high pressure of the fluid in the cell manifold 112 forces the backwash jet 322 counter to the biasing spring, thereby opening the backwash jet and allowing fluid to flow into the media chamber 310 to fluidize and clean the GFM 311. When the flow through the cell 300 is returned to the normal flow for filtration, the spring biases the backwash jet 322 closed at the moment during the flow change when there is no flow, thereby reliably preserving the GFM 311 within the media chamber 310 of the cell 300.

In another embodiment, a backflow seal is provided around the backwash jet that prevents the GFM 311 from entering the backwash jet during transition between the filtering and backwashing cycles. In one embodiment, a cup seal is utilized that includes an flexible outer lip that flexes inward to allow the passage of the high pressure backwash flow and flexes outward to seal and retain the GFM 311 within the media chamber 310. Additional seals may be utilized in and around the backwash jet 322 to prevent further backflow of the GFM 311 into the backwash jet during filtration.

The flow of fluid through the filter cell 300 during a backwash cycle is illustrated in FIG. 5. In particular, the backwash cycle of the cell 300 includes several operations. First, through hydraulic pressure during the backwash cycle of the cell 300 (created by a high pressure within the cell manifold 312), the bell check 318 portion of the filter cell 300 is moved upward to engage the outer surface of the filter cell 302. In one embodiment, a bell check seal is present on the rim of the bell check 318 that engages with the outer surface of the filter cell 302 to form a fluid-tight seal and force all of the reversed flow to go through the backwash jet 322 during the backwash cycle. Next, the compaction force on the GFM 311 by the compaction piston 306 is released by locating the high pressure inside the media chamber 310, thereby diverging the two screened media barriers (the dirty screen 308 of the compaction piston 306 and the screened media barrier 314 of the media chamber). This operates to increase the volume of the GFM and allows for the granules of the GFM to be fluidly agitated during the backwash cycle. Third, a cleaning fluid 332 passes through the backwash jet 320 and into the media chamber 310 to clean and agitate the GFM 311. During this phase, contaminates contained in the GFM are removed from the GFM, flow back through the compaction piston 306 and out of the filter cell through the influent connection, as indicated in the flow indicators of FIG. 5. Once the GFM is cleaned, the direction of flow is again reversed back to normal flow for filtration, the compaction piston 306 re-compacts the GFM (through the compaction biasing component), and the bell check is returned to the filtering state so that the filter cell 300 can once again filter fluid through the cell. Further, due to the filter cell 300 design, the use of the high-pressure backwash jet 320 into the media chamber 310 provides a dual-speed cleaning process to the backwash cycle. Namely, the high velocity backwash jet 320 provides a high-speed cleaning of the GFM and the backflow of the fluid through the upper portion of the filter cell provides a relatively slower flow to discharge contaminates away from the GFM.

By utilizing a backwash jet 320 that is located within the body of the GFM, some advantages over previous backwashing designs are gained. For example, previous RFF filters utilize a backwash jet that shoots the cleaning fluid through one of the screened media barriers of the filter. This design attempts to prevent the backflow of the GFM into the backwash jets 322. However, jet force is substantially reduced when passing through a screen, and the resulting flow stream is similar to the soft flow of a sink faucet aerator. In contrast, by placing the backwash jet 320 directly into or adjacent the GFM, a better and more thorough cleaning of the media may occur over previous filter designs. In addition, the high velocity of the wash water leaving the backwash jet 322, and the low velocity of the water leaving the cell 300 removing the dirt in the process, together provide a synergistic dual velocity cleansing of the GFM 311 within the cell.

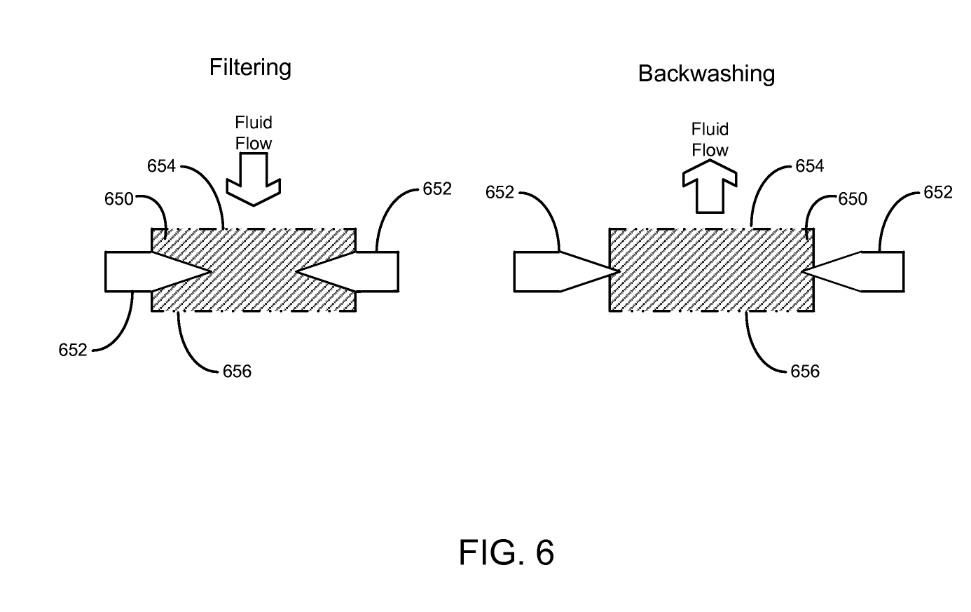

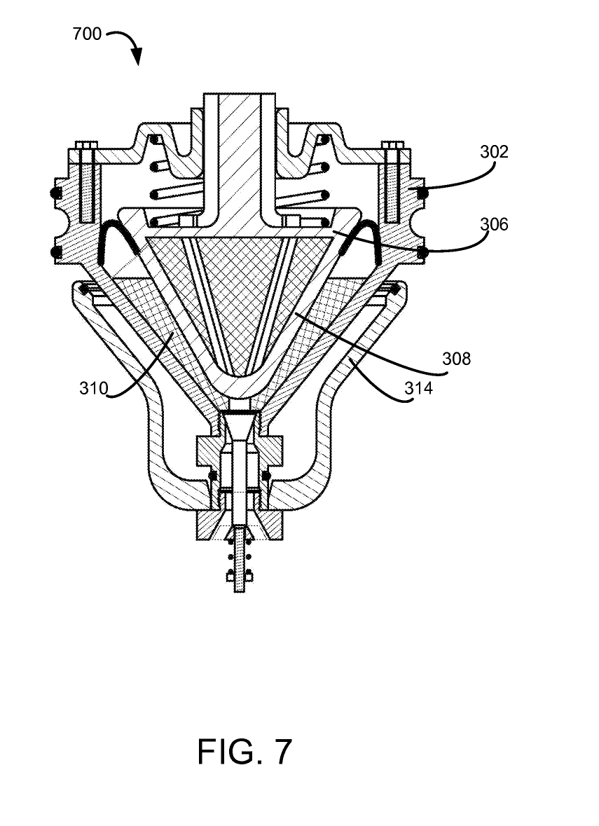

A variation of a compaction method of the filter cell is illustrated in FIG. 6. In particular, FIG. 6 is a cross section view of one embodiment of a compaction element of a filter cell of a filter system that utilizes positive displacement compaction of the GFM of the filter cell. As discussed above, the filter cell of the filter system described herein may utilize two screened media barriers where either or both barriers move in relation to each other for the purpose of compacting a GFM for filtration by converging (and thereby compacting the GFM into a tight bed), and then releasing the compaction force to allow the GFM to fluidize in the backwash flow stream. An alternate compaction mechanism for a filter cell of a filter system is shown in FIG. 6.

In particular, FIG. 6 provides a simplified cross-section of the GFM 650 of a filter cell, such as the filter cell described above with reference to FIGS. 3-5. The GFM 650 is maintained between a dirt screen barrier 654 and a clean screen barrier 656. As described above, one embodiment of the filter cell mechanically or otherwise moves one or both of the dirt screen barrier and the clean screen barrier to compact the GFM during a filtration cycle of the filter cell. In the embodiment of FIG. 6, however, the dirt screen barrier 654 and the clean screen barrier 656 may be fixed relative to each other. In this particular embodiment, the GFM 650 may be compacted through one or more compaction elements 652 located adjacent to the GFM, such as the compaction elements 652 illustrated in FIG. 6. In particular, the compaction elements 652 are located between the fixed screen barriers 654,656 and adjacent the GFM 650. In general, the compaction elements 652 may move mechanically, hydraulically, or pneumatically into the GFM 650 to displace space, and as a result, compact the GFM for fluid filtration. The movement of the compaction elements 652 into the GFM 650 acts to compact the GFM between the dirt screen barrier 654 and the clean screen barrier 656. In the embodiment illustrated in FIG. 6, the compaction elements 652 are wedge-shaped elements that are moveable into the GFM 650.

After the filtration cycle is complete, the filter cell may enter a backwashing phase to clean the GFM 650. In this phase, the compaction elements 652 of the embodiment of FIG. 6 are mechanically, hydraulically, or pneumatically retracted from the GFM 650 to release the compaction pressure on the GFM so that it can be fluidized for backwashing in preparation for the next sequential filtration cycle. Movement of the compaction elements 652 back into the GFM 650 provides the re-compaction of the GFM for further filtration.

Other embodiments of the compaction elements 652 of the filter cell may take the form of cylindrical or conical moving parts which can be mechanically, hydraulically, or pneumatically forced into the GFM for filtration, and then mechanically, hydraulically, or pneumatically retracted back out for backwashing. Yet other embodiments of the compaction elements 652 may be one or more elastomeric balloon-like or innertube-like inflatable element which inflates either pneumatically or hydraulically to compact the GFM and deflates to release the compaction force and allow the GFM to fluidize for backwashing.

Several advantages are provided to the filter cell when utilizing a positive displacement compaction element such as those shown in FIG. 6. For example, in positive displacement compaction, the GFM 650 is compacted to filtration bed depth progressively as opposed to attempting to compact all of the GFM to filtration bed depth at the same time, such as when the compaction is provided by moving together the screened media barriers. Also, positive displacement compaction results in a higher mechanical advantage against the GFM 650 during compaction than a design which “vises” all of the media between two converging flat screened media barriers which attempt to compact the entire media body to a final uniform, not variable, filtration bed depth at the same time.

Another approach to compaction other than using fixed screened media barriers and inserting or inflating the positive displacement compaction elements 652 into the GFM 650 is to incorporate positive displacement compaction into the design geometry of the compaction piston that is incorporated into the filter cell. FIG. 7 illustrates one such design and shows a cross section view of one embodiment of a filter cell 700 of a filter system that utilizes center point compaction of the GFM of the filter cell. Through the use of the compaction piston illustrated in FIG. 7, several advantages of compaction of the GFM 703 in the filter cell are obtained.

In general, the filter cell 700 of FIG. 7 is the same or a similar filter cell as that illustrated in FIG. 3 and discussed above. Thus, similar components of the filter cell 700 of FIG. 7 include similar or the same identifying numbers as that illustrated in FIG. 3. In addition, the operation and description of those components discussed above apply generally to the same components of the filter cell 700 of FIG. 7. However, the filter cell 700 of FIG. 7 is utilized herein to describe the function of the center point compaction of the GFM 703 by the compaction piston 306 of the filter cell.

As shown in the filter cell 700, the compaction piston 706 and the media chamber 710 have a conical or partially conical shape, with the GFM 703 located within the media chamber under the compaction piston 706. During a filtering phase of the filter cell 700, the compaction piston 706 is mechanically, hydraulically, or pneumatically forced into the GFM 703 to compact the media. In particular, due to the conical shape of the compaction piston 706, the piston exerts a center point compaction that begins in the center of the media chamber 710 and progressively works radially outwards. In other words, as the compaction piston 706 plunges into the fluidized GFM 703 after backwashing, the media extrudes radially outwards until its movement is stopped against the filter cell wall 702. Of particular note, the GFM 703 thus may not have a uniform thickness through the media bed. Rather, the thickness of the GFM 703, when compacted, may be the least at the center point of the compaction (and the center point of the conical shape compaction piston 706) and thicker along the media bed toward the filter cell wall to create the variable bed depth of the GFM. Further, the outward extrusion of the GFM 703 during center point compaction ensures that the GFM 703 compacts uniformly such that no cracks, breaks or voids in the GFM occur through which unfiltered fluid may flow. As such, a more reliable regenerative filtration of fluids by the filter cell 700 may be achieved with the center point compaction of the GFM 703 when compared with flat compaction of the GFM.

In addition, the center point compaction utilizing the compaction piston 706 as shown greatly increases the effective surface area of the body of GFM 703 within the filter cell 700 over that of a flat compaction piston. This increase in filter surface area is accomplished through two features of the conical compaction piston 706. First, the conical shape provides the GFM 703 from having a vertical surface when compared with a flat compaction along the length of the media. Second, the compaction piston 706 may be constructed as a series of support ribs which support the dirty screen 708 of the compaction piston to maintain the conical shape of the piston. The area between the support ribs may create a “hammocking” effect as the screen between the support ribs of the compaction piston 706 creates convolutions. Both the length of the compaction piston 706 and the depth and number of convolutions of the compaction piston can be increased to further increase the effective interface area of the body of GFM through which the fluid to be filtered flows. This may in turn increase the flow rate, capacity for contaminant, and efficiency of the filter cell over previous, flat compaction designs.

Initial testing of the regenerative fluid filtration micro-cell, such as that shown above with reference to FIGS. 3-7, indicate that the smaller the size results in more reliable operation. This testing has indicated that the preferred optimum size for the cell is such that the internal media chamber of the cell has an outside diameter from 3.0″ to 4.5″. Depending on the type of GFM used, and the size of the cell, clean flow rates have ranged from 4 to 10 gallons per minute (GPM) at a pressure drop (ΔP) of 5 pounds per square inch (PSI).

Embodiments of the present disclosure include various steps, which are described in this specification. The steps may be performed by hardware components or may be embodied in machine-executable instructions, which may be used to cause a general-purpose or special-purpose processor programmed with the instructions to perform the steps. Alternatively, the steps may be performed by a combination of hardware, software and/or firmware.

Various modifications and additions can be made to the exemplary embodiments discussed without departing from the scope of the present invention. For example, while the embodiments described above refer to particular features, the scope of this invention also includes embodiments having different combinations of features and embodiments that do not include all of the described features. Accordingly, the scope of the present invention is intended to embrace all such alternatives, modifications, and variations together with all equivalents thereof.

We claim:

1. A filter system comprising:
a housing comprising an influent pipe for input of a contaminated fluid into the housing and an effluent pipe for output of a filtered fluid from the housing;
a cell manifold enclosed in the housing; and
a plurality of filter cells maintained on the cell manifold, wherein each filter cell of the plurality of filter cells comprises:
a granular filtration media (GFM) maintained within a media chamber;
a compaction element to compact the GFM within the media chamber; and
a backwash jet to fluidize the GFM during a backwash cycle,
wherein each of the plurality of filter cells is configured to filter contaminates out of the contaminated fluid by passing the contaminated fluid through the GFM.

2. The filter system of claim 1, wherein the compaction element of at least one of the plurality of filter cells comprises a compaction piston and a biasing component associated with the compaction piston, the biasing component configured to force the compaction piston into the GFM to create a center point compaction of the GFM of the at least one of the plurality of filter cells.

3. The filter system of claim 2, wherein the center point compaction of the GFM radially exudes the GFM along a length of a GFM bed.

4. The filter system of claim 2, wherein the compaction piston of the at least one of the plurality of filter cells comprises a compaction piston screened media barrier through which the contaminated fluid flows to filter large contaminates from the contaminated fluid.

5. The filter system of claim 2, wherein the GFM is an ultra-high molecular weight polyethylene material.

6. The filter system of claim 2, wherein the backwash jet of the at least one of the plurality of filter cells is configured to provide a high-pressure cleaning fluid to the GFM.

7. The filter system of claim 6, wherein the backwash jet is in fluid communication with the filtered fluid for fluidizing of the GFM.

8. The filter system of claim 1, wherein the compaction element of at least one of the plurality of filter cells comprises a wedge movable into the GFM of the at least one of the plurality of filter cells.

9. The filter system of claim 8 wherein the wedge is movable into the GFM through a pneumatic motor associated with the movable wedge.

10. The filter system of claim 2, wherein the biasing component is a spring connected to the compaction piston.

11. The filter system of claim 3, wherein the granular media bed is variable along the length of the granular media bed.

12. The filter system of claim 2, wherein the GFM of the at least one of the plurality of filter cells comprises at least two different types of filtering media.

13. The filter system of claim 1, wherein the plurality of filter cells maintained on the cell manifold comprises at least a first filter cell comprising a first type of GFM maintained within the media chamber of the first filter cell and a second filter cell comprising a second type of GFM maintained within the media chamber of the second filter cell, wherein the first type of GFM is different than the second type of GFM.

14. The filter system of claim 1, wherein the cell manifold is a cylinder shape.

15. A filter device for filtering contaminates from a fluid, the device comprising:
a cell manifold; and
a plurality of filter cells maintained on the cell manifold, wherein each filter cell of the plurality of filter cells comprises:
at least one fluid-tight seal located between the filter cell and the cell manifold;
a granular filtration media (GFM) maintained within a media chamber;
a compaction element configured to compact the GFM within the media chamber; and
a backwash jet to fluidize the GFM during a backwash cycle;
wherein each of the plurality of filter cells is configured to filter contaminates out of a contaminated fluid by passing the contaminated fluid through the compacted granular media.

16. The filter device of claim 15, wherein the compaction element comprises a compaction piston and a biasing component associated with the compaction piston, the biasing component configured to force the compaction piston into the GFM to create a center point compaction of the GFM within the media chamber.

17. The filter device of claim 16, wherein the center point compaction of the GFM radially exudes the GFM along a length of a GFM bed.

18. The filter device of claim 16, wherein the compaction piston of the at least one of the plurality of filter cells comprises a compaction piston screened media barrier through which the contaminated fluid flows to filter large contaminates from the contaminated fluid.

19. The filter device of claim 16, wherein the biasing component is a spring connected to the compaction piston.

20. The filter device of claim 16, wherein the granular media bed is variable along the length of the granular media bed.
